(19) United States
(12) Patent Application Publication
(10) Pub. No.: US 2020/0277943 A1
(43) Pub. Date: Sep. 3, 2020

(54) POSITIVE DISPLACEMENT PUMP HAVING FLOW-PROMOTING SURFACES

(71) Applicant: ProMinent GmbH, Heidelberg (DE)

(72) Inventors: Reiner GAMPERLING, Waibstadt (DE); Bernd FREISSLER, Dielheim (DE); Alexander BUBB, Schwetzingen (DE)

(21) Appl. No.: 16/805,629

(22) Filed: Feb. 28, 2020

(30) Foreign Application Priority Data
Feb. 28, 2019 (DE) 102019105191.8

(51) Int. Cl. F04B 15/08; F04B 51/00

(52) U.S. Cl. CPC F04B 15/08; F05B 2280/5011; F04B 2201/08; F04B 51/00

(57) ABSTRACT

The present invention relates to a positive displacement pump having a delivery chamber, which is connected to a discharge connection and a suction connection, characterized in that the surface of the delivery chamber is configured in the form of an at least partially microstructured surface. The at least partially microstructured surface has a multiplicity of ribs and channels located therebetween, these running in a direction along the direction of flow of the delivery medium. As a result of the surface being structured, the situation where gas bubbles stick is reliably prevented and the harmful gas volume is considerably reduced.

The present invention relates to a positive displacement pump having a delivery chamber, which is connected to a discharge connection and a suction connection. The positive displacement pump also has a displacing element which determines the volume of the delivery chamber and can be moved back and forth between a first position, in which the delivery chamber has a relatively small volume, and a second position, in which the delivery chamber has a relatively large volume. It is usually the case that the discharge connection is connected to the delivery chamber via a discharge valve designed in the form of a non-return valve and that the suction connection is connected to the delivery chamber via a suction valve designed likewise in the form of a non-return valve.

Hydraulic diaphragm pumps additionally have a working chamber, which is separated from the delivery chamber by a diaphragm. In order to deliver a medium, the diaphragm is moved back and forth in oscillating fashion between a first position and second position, by the working chamber being filled with a hydraulic fluid which is subjected to an oscillating pressure. The two positions of the diaphragm are usually referred to here as the discharge-stroke position and the suction-stroke position.

In order to deliver a medium, the displacing element is moved back and forth in oscillating fashion between the first position and second position. When the displacing element is moved from the first position into the second position, the so-called suction stroke, the volume of the delivery chamber is increased, as a result of which the pressure in the delivery chamber drops. As soon as the pressure in the delivery chamber falls below the pressure in a suction line connected to the suction connection, the suction valve opens and medium which is to be delivered is taken into the delivery chamber via the suction connection. As soon as the displacing element moves from the second position in the direction of the first position again (this is the so-called discharge stroke), the volume in the delivery chamber decreases and the pressure in the delivery chamber increases. The suction valve is closed, in order to prevent the medium which is to be delivered from flowing back into the suction line. As soon as the pressure in the delivery chamber exceeds the pressure in a discharge line connected to the discharge connection, the discharge valve is opened, and therefore the delivery medium which is located in the delivery chamber can be forced into the discharge line.

Such a positive displacement pump designed in the form of a diaphragm pump is disclosed, and described, in EP 1 546 557 B1.

When liquids, in particular gas-emitting delivery media, for example sodium hypochlorite (NaClO), are being metered, it is possible for gas bubbles to form in the suction line connected to the suction connection and to be sucked into the metering head. It is also possible for gas bubbles to form in the delivery chamber. This is often the case following relatively long metering stoppages, for example after a weekend. Since the suction connection is connected to a suction line which, in the simplest case, is designed in the form of a hose and terminates in a storage container, changeover of the storage container, in particular when the pump is operating, can result in the suction line for a brief time no longer being connected to the delivery medium and taking in gas, e.g. air.

Furthermore, gas bubbles formed tend to adhere to the surface of the metering head.

If there is too much gas located in the metering head of an oscillating delivery pump (this phenomenon being referred to as the “harmful volume”), then the metering operation can be disrupted if the inherent compression capability of the metering head is insufficient, on account of the volume of gas enclosed, to open the discharge valve counter to the non-return spring, the weight of the closing body and the system pressure. In other words, if the fraction of gas in the delivery chamber becomes too high, then, despite the movement of the displacing element from the second position into the first position, it may be the case that the pressure in the delivery chamber does not increase sufficiently in order to open the discharge valve connected to the discharge connection. This is caused by gas being highly compressible in comparison with liquids.

Therefore, if it is no longer possible for the displacing element to apply a sufficiently high pressure to open the discharge valve, the delivery medium is not pumped, i.e. the desired metering operation cannot take place.

In order for it to be possible to move away from this defective state, it is necessary to restore the compression capability to the counterpressure which is present at the discharge connection. This can take place by some liquid once again being transferred into the delivery chamber, in order to improve the relationship between compressible and incompressible media such that the pressure which is built up by the movement of the delivery element can once again reach the counterpressure which is present at the discharge connection.

In the case of the delivery pump which is disclosed in EP 1 546 557 B1, there is therefore an additional connection provided between the delivery chamber, on the one hand, and the discharge connection, on the other hand, and this additional connection is opened intermittently in order to allow liquid to re-enter from the discharge line into the delivery chamber, as a result of which gas can escape from the delivery chamber at the same time, and therefore the relationship between compressible gases and incompressible liquids improves again and, ideally, it is once again possible to achieve, in the delivery chamber, the counterpressure which is present at the discharge connection.

However, this solution involves relatively high outlay, since, alongside an additional bypass line, it is necessary to provide a valve for closing said bypass line and also an activating device for activating the valve.

Therefore, WO 2013/135681 A1 has proposed designing the discharge valve in a non-sealed state, and therefore, even when the discharge valve is closed, a return-flow channel connects the delivery chamber and discharge connection, it being possible for medium to pass through said return-flow channel into the delivery chamber and/or for gas to escape from the delivery chamber through said return-flow channel.

However, this embodiment has the disadvantage that the delivery characteristics depend on the pressure in the discharge line connected to the discharge connection. In particular whenever pumping is to take place counter to a very high pressure, the quantity of delivery fluid which flows back into the delivery chamber through the non-sealed discharge valve increases considerably, and therefore the metering capacity is reduced. Furthermore, when use is made of a non-sealed discharge valve, the problem of gas bubbles adhering to the surface of the delivery chamber remains.

Taking the abovedescribed prior art as a departure point, it is therefore the object of the present invention to provide a positive displacement pump which is self-venting and, at the same time, reliably provides a degassing function.

This object is achieved according to the invention in that the surface of at least one positive-displacement-pump element which is in contact with fluid is configured in the form of an at least partially microstructured surface. As a result, the situation where gas bubbles stick is reliably prevented and the harmful volume is considerably reduced.

It can, in particular, be advantageous here if the surface of the delivery chamber, of the working chamber, of the lines, of the displacing piston, of the diaphragm, of the valves and/or of all the other positive-displacement-pump elements which are in contact with fluid is or are configured in the form of an at least partially microstructured surface. Lines and/or bores are also intended here to denote, in general terms, fluid-guiding channels and generally represent the (through-) passage and guidance of fluids.

Further advantageous exemplary embodiments of the present invention form the subject matter of the dependent claims.

Scales of fast-swimming sharks have, for example, microscopically small ribs or “riblets” in the longitudinal direction. As a result of the riblets, during turbulent flow, the components of the vortices which run transversely to the direction of flow are impeded. Surface structures which are particularly beneficial for large components can be derived therefrom. An appropriate flow-promoting coating can be used to reduce, for example, the fuel consumption of aircraft and ships by up to three percent:

http://www.ifam.fraunhofer.de/content/dam/ifam/de/documents/Kl ebtechnik_Oberflaechen/Lacktechnik/riblets_fraunhofer_ifam.pdf
http://www.uni-saarland.de/fak8/bi13wn/projekte/umsetzung/fischhaut.html
http://rwscharf.homepage.t-online.de/faz06/faz0308.html

Microstructured surfaces such as the previously cited flow-promoting “riblet” surfaces, or those with the lotus-leaf structure, are required more and more for special functions. Products which can be optimized in terms of speed and energy consumption as a result of flow-promoting surfaces are basically, on the one hand, objects which are self-propelling, for example aircraft, rail vehicles, automotive vehicles, ships or also rotor blades of wind turbines, and, on the other hand, objects around which, or through which, movement is to take place, e.g. pipelines. In addition, microstructured surfaces serve to reduce fouling or growth of vegetation (in particular in respect of ships).

A riblet structure usually has ribs and channels located therebetween. The channels are depressions in the surface of the component. The ribs are arranged such that recessed channels or grooves run between adjacent ribs. It is usually the case that the ribs and channels here run in a direction along the direction of flow of the delivery medium over the corresponding surface.

Provision can be made here, according to one embodiment, for the ribs and channels to be arranged at least partially, in particular fully, in segmented form, wherein the individual segments are offset in relation to one another, and wherein it is possible for the respective segments to be of identical length or of different lengths.

It can also be advantageous here for the ribs and channels to be of different heights and widths.

As an alternative, or in addition, provision can also be made for the ribs to be designed at least partially, in particular fully, in honeycomb form, wherein the honeycomb boundary interrupts the ribs and channels.

As a result of a riblet structure being applied, during turbulent flow, the components of the vortices which run transversely to the direction of flow are impeded. This results in a reduction in the frictional resistance and an increase in the flow speed in the wall vicinity. The latter gives rise here, surprisingly, to increased “entrainment” of gas bubbles adhering to critical locations of the surface of the delivery chamber. In addition, the structure according to the invention reduces vibration and noise.

The at least partially microstructured surface of the delivery chamber can be produced in the form of films, for example by extrusion or imprinting methods, the films then being adhesively bonded to the respective workpiece.

For the purpose of structuring films, imprinting methods which imprint films, or film-like materials, in stationary machines are known. EP 0 205 289 A1 discloses, for example, a method in which a microstructure is applied to a film using a roller. It is also the case that WO 2013/050018 A1 describes a riblet foil and a method for producing the same.

The material of which the surface is to be microstructured must nevertheless be basically flexible, so that it can be guided over a pressure-exerting roller. For the purpose of structuring a non-flexible, rigid object such as, for example, the inner surface of a delivery chamber of a pump, therefore, methods which do not use film are more suitable. For example, a lacquer which is applied to the inner surface of a delivery chamber of a pump can be structured directly. Such a method for microstructuring surfaces by selective application of a curable coating material is known, for example, from WO 2005/030472 A1.

The depressions of a riblet structure can also be produced using a pulsed laser beam or using fine jet plasma, wherein the structures are introduced either directly into the surface of the delivery chamber or into film or lacquer applied to the surface. The channels and/or ribs are formed by individual laser pulses, which preferably follow one another and form a continuous structure. Use is preferably made of a femto laser for the purpose of forming the riblet structure.

If a riblet structure is introduced into film or lacquer applied to a surface, particular importance is attached to the materials which are to be selected as the film or lacquer. On the one hand they have to be resistant to the medium which is to be delivered; on the other hand they have to adhere well to the surface and to be capable of being structured by suitable methods. A person skilled in the art will select the material which is suitable for the respective pump and is resistant to the delivery medium. This is usually a polymer-based material. The adhesion thereof to the surface can be optimized by suitable adhesives and/or adhesion promoters and/or sizes. Furthermore, the inclusion of polar functional groups in the polymer can improve the adhesion to polar surfaces even without use being made of adhesion promoters or sizes.

The riblet ribs are only a few μm high and preferably have a height from 0.3 to 1000 μm, in particular between 30 and 300 μm, wherein the ribs have a height between 30% and 120%, preferably between 50% and 100%, of the distance from an adjacent rib.

The ribs have a width ranging from approximately 0.3 μm to 1000 μm, preferably 25 μm to 300 μm, in particular 35 μm to 200 μm.

The channels have a width ranging from approximately 0.3 μm to 1000 μm, preferably 25 μm to 300 μm, in particular 35 μm to 200 μm, wherein the channels are preferably rounded and/or tapered in relation to the ribs in particular at an acute angle of smaller than, or equal to, 75°, in particular smaller than, or equal to, 60°.

It has been found that channels which are rounded in particular in relation to the ribs have achieved particularly good effects. This applies, as it were, to channels which taper virtually to a point and preferably to a combination of channels which taper to a point and form a rounded transition in relation to the ribs. The latter combination has proven particularly advantageous for a number of applications.

Channels and ribs are arranged preferably parallel and in the direction of flow. However, other arrangements are also possible.

Oscillating positive displacement pumps modified by microstructured surfaces are distinguished by high, stable metering accuracy, improved hydraulic/energy efficiency and good intake behaviour. The microstructured-surface modification according to the invention is advantageously used in particular in the case of pumps which are designed for metering small quantities. However, the technology according to the invention is also suitable for use with other delivery-pump systems, for example centrifugal pumps.

A function test was carried out in order to demonstrate the functioning of the invention. The function test involved comparing two identical pumps, one equipped with a standard PLEXIGLAS® metering head and the other equipped with an identical standard PLEXIGLAS® head with additionally microstructured surfaces (riblet structure) in the delivery chamber.

Then, start-up was simulated for both pumps, the metering head typically being filled with air and, at the start of the delivery operation, always some residual air/gas having to be taken in as well from the suction pipe.

It is usually the case that the air from the metering head and suction line is delivered out within 20 to 60 seconds (oscillating positive displacement pumps are self-priming) and normal operation with fluid takes over.

On a PLEXIGLAS® head, this operation can be observed to good effect and any bubbles of air and gas which may also remain in the delivery chamber can be easily identified.

On the standard metering head, the function test identified gas bubbles which remain in the delivery chamber following the start-up cycle and are also still present after a relatively long period of operation.

On the riblet metering head, the metering head is free of bubbles of air and gas following the start-up phase.

It was therefore possible to show that no formation of air bubbles is identified when use is made of the microstructured surfaces according to the invention.

1. Positive displacement pump having a delivery chamber, which is connected to a discharge connection and a suction connection, characterized in that the surface of at least one positive-displacement-pump element which is in contact with fluid is configured in the form of an at least partially microstructured surface.

2. Positive displacement pump according to claim 1, characterized in that
the surface of the delivery chamber, of the working chamber, of lines and/or bores in the pump, of the displacing piston, of the diaphragm, of the valves and/or of all other positive-displacement-pump elements which are in contact with fluid is or are configured in the form of an at least partially microstructured surface.

3. Positive displacement pump according to claim 1, characterized in that
the surface or the surfaces have or has a multiplicity of ribs and channels located therebetween.

4. Positive displacement pump according to claim 1, characterized in that
ribs and channels run at least partially, in particular fully, in a direction along the direction of flow of the delivery medium.

5. Positive displacement pump according to claim 1, characterized in that
the ribs and channels are arranged at least partially, in particular fully, in segmented form, wherein the individual segments are offset in relation to one another, and wherein it is possible for the respective segments to be of identical length or of different lengths.

6. Positive displacement pump according to claim 1, characterized in that
the ribs and channels are arranged at least partially, in particular fully, in segmented form, wherein it is possible for the individual segments to have ribs and channels of different heights and widths.

7. Positive displacement pump according to claim 1, characterized in that
the ribs are designed at least partially, in particular fully, in honeycomb form, wherein the honeycomb boundary interrupts the ribs and channels.

8. Positive displacement pump according to claim 1, characterized in that
at least one of the ribs, preferably all the ribs, in a single segment, in particular all the ribs, are pointed and at least one of the channels, preferably all the channels, in a single segment, in particular all the channels, are round.

9. Positive displacement pump according to claim 1, characterized in that
at least one of the ribs, preferably all the ribs, in a single segment, in particular all the ribs, and at least one of the channels, preferably all the channels, in a single segment, in particular all the channels, are triangular and/or trapezoidal.

10. Positive displacement pump according to claim 1, characterized in that
the ribs have a height from 0.3 to 1000 μm, preferably between 30 and 300 μm.

11. Positive displacement pump according to claim 4, characterized in that
the ribs have a height between 30% and 120%, preferably between 50% and 100%, of the distance from an adjacent rib.

12. Positive displacement pump according to claim 3, characterized in that
the ribs have a width from 0.3 μm to 1000 μm, preferably 25 μm to 300 μm, in particular 35 μm to 200 μm.

13. Positive displacement pump according to claim 3, characterized in that
the channels have a width from 0.3 μm to 1000 μm, preferably 25 μm to 300 μm, in particular 35 μm to 200 μm, wherein the channels are preferably rounded and/or taper in relation to the ribs in particular at an acute angle of smaller than, or equal to, 75°, in particular smaller than, or equal to, 60°.

14. Method for producing an at least partially microstructured surface of an element of a positive displacement pump, in particular of a delivery chamber, working chamber, of lines and/or bores in the pump, of a displacing piston, of a valve, of a line and/or a seal, preferably of a positive displacement pump according to claim 1, characterized in that
a microstructured film is adhesively bonded to the surface and/or the microstructured surface is produced by casting or injection moulding and/or by imprinting and/or by machining, in particular milling, and/or a lacquer applied to the surface is structured and/or the structure is produced using a pulsed laser beam or using fine jet plasma.

15. Use of microstructured surfaces for optimizing the harmful volume of pumps and/or for reducing noise or vibration in pumps, in particular by coating the delivery chamber, the working chamber, lines and/or bores in the pump, the displacing piston, the diaphragm and/or seals of the pump, preferably in a positive displacement pump according to claim 3.
